(19) United States
(12) Patent Application Publication
(10) Pub. No.: US 2015/0097306 A1
(43) Pub. Date: Apr. 9, 2015

(54) VALVE DEVICE FOR CONTROLLED INTRODUCTION OF A BLOWING MEDIUM

(71) Applicant: KRONES AG, Neutraubling (DE)

(72) Inventors: Dieter Finger, Neutraubling (DE); Eduard Handschuh, Donaustauf (DE); Florian Geltinger, Donaustauf (DE)

(21) Appl. No.: 14/507,500

(22) Filed: Oct. 6, 2014

(30) Foreign Application Priority Data
Oct. 4, 2013 (DE) 10 2013 111 025.8

(51) Int. Cl. F16K 31/00; B29C 49/60; B29C 49/12; F16K 31/124; B29C 49/78

(52) U.S. Cl. CPC F16K 31/007; F16K 31/124; B29C 49/783; B29C 49/12; B29C 49/60; B29C 2949/7889; B29C 2949/78537
USPC 264/40.3; 251/30.01; 251/248; 425/162; 425/149

(57) ABSTRACT

A valve device for controlled introduction of a blowing medium into plastic parisons, includes at least one controllable valve body, at least one actuating device, and a control device for controlling the actuating device. The actuating device is at least indirectly operatively connected to the valve body, and includes at least one piezoelectric actuator, wherein by actuation of the actuating device and control of the piezoelectric actuator, which is associated therewith, by the control device in dependence on the current impressed into the piezoelectric actuator and/or the voltage applied thereto, the valve body can be moved from an open position into a closed position and vice versa, and in the closed position a main flow path for introduction of the blowing medium into the plastic parisons is closed.

The present invention relates to a valve device for controlled introduction of a blowing medium into plastic parisons, comprising at least one controllable valve body, at least one actuating device, and also a control device for controlling the actuating device, wherein the actuating device is at least indirectly operatively connected to the valve body, according to the preamble to Claim 1.

In this case it may be noted that the expression “indirectly” means that either the actuating device engages in the valve body directly, i.e. without additional components between the valve body and the actuating device, and for example moves the valve body, or that further moving elements which for example transmit a movement of the actuating device are disposed between the actuating device and the valve body. Therefore if further elements to be separated from the actuating device are disposed between the actuating device and the valve body, the actuating device merely engages indirectly in the valve body.

A large number of different valve devices for controlled introduction of a blowing medium into plastic parisons are known from the prior art.

For example, a device for pneumatically controlling a blowing pressure for blow moulding of containers is known from the document EP 1 271 029 B1. In this case a plastic or metal piston is used, wherein the piston is controlled and moved pneumatically, for example by means of a pilot valve. For this purpose the pilot valve can be controlled by an electrical signal. Although in this document particularly high transmission ratios, that is to say a particularly high pressure of the process air (up to 40 bars) by means of a high control air pressure (up to 12 bars), are possible, the valve device shown in the document D1 has very high valve switching times. Such valve switching times may be up to 2 milliseconds, so that in particular in the above document attempts are also made to reduce the valve switching times as much as possible by individual introduction of the control air. Therefore in particular the valve device shown in the document EP 1 271 029 B1 has not only a particularly long valve switching time but also a high compressed air consumption. Furthermore a variable stroke length of the valve device can be achieved for example only by additional mechanical stops.

It is therefore an object of the present invention to provide a valve device which eliminates the above-mentioned disadvantages and therefore makes it possible to provide a valve device which has particularly low valve switching times and at the same time is configured for especially high pressures and/or pressure conditions and is also cost-effective to produce.

This object is achieved by the subject matter of Claim 1. Further embodiments are described in the dependent claims.

In order now to provide a valve device for controlled introduction of a blowing medium into plastic parisons, which valve device has particularly low valve switching times, is cost-effective to produce and furthermore is configured for particularly high pressures and/or pressure conditions, the present invention makes use inter alia of the idea that the actuating device comprises at least one piezoelectric actuator, wherein by means of actuation of the actuating device and a control of the piezoelectric actuator, which is associated therewith, by the control device in dependence on the current impressed into the piezoelectric actuator and/or the voltage applied thereto (of preferably at least 12 V and at most 200 V) the valve body can be moved from an open position into a closed position and vice versa, and in the closed position a main flow path for introduction of the blowing medium into the plastic parisons is closed. In particular the actuating device may be constructed in the form of a 2/2-way or a 3/2-way valve, for example a pilot valve.

Basically a piezoelectric element is a component which utilises the piezoelectric effect in order either to carry out a mechanical movement by the application of an electrical voltage (piezoelectric actuator, used in the so-called inverse piezoelectric effect) or to generate an electrical voltage when a mechanical force is exerted.

Piezoelectric elements may be specific crystals (piezoelectric crystals or piezoelectric ceramics), that is to say for example polycrystalline materials. Ceramics are particularly suitable for use of a piezoelectric element, that is to say a piezoelectric actuator, since these produce a greater alteration in length than piezoelectric crystals even at lower voltages.

For example, electrodes are applied to the piezoelectric material, that is to say the piezoelectric actuator, so that an electrical field is produced by the applied voltage or the electrical field generated by a mechanical force causes a voltage on the electrons.

In the simplest situation a piezoelectric element is constructed in the form of a small plate with electrodes on the end surfaces, wherein the plate expands in the direction of the thickness and contracts in the transverse direction when a voltage is applied. The deformation preferably persists as long as the voltage is applied. If no changing external forces occur, then no energy is required to maintain the deformation. If the polarity of the voltage is reversed, the direction of the deformation changes, and therefore in this case contractions take place in the direction of the thickness and expansions take place in the transverse direction.

Due to the use of the piezoelectric element as the piezoelectric actuators described here, high movement amplitudes are preferably desirable at lower voltages. Since the relative longitudinal expansion is proportional to the electrical field strength, this can be achieved by a small spacing between the electrodes. In this respect the above invention claims and describes that by the impression of current and/or voltage into the piezoelectric actuator this latter is deformed and the valve body is moved mechanically by means of the deformation of the piezoelectric actuator and thus also by the at least indirect operative connection of the piezoelectric actuator to the valve body, so that the valve body can be moved either from a closed position into an open position or vice versa, depending upon the polarity of the voltage on the piezoelectric actuator by which itself the valve body can be moved.

In this respect by means of the valve device described here comprising the at least one piezoelectric actuator, for the first time the principle of “piezoelectric elements” is integrated in a particularly simple manner in a valve device for controlled introduction of a blowing medium into plastic parisons, so that the present invention makes use of the surprising knowledge that by means of the piezoelectric actuator described here valve devices can be provided which not only withstand high pressures and/or pressure conditions but for which also especially low switching times can be achieved by means of individual control of the control device. Therefore the valve device described here, and in particular the actuating device described here comprising the at least one piezoelectric actuator, in a particularly simple and advantageous manner offers the possibility of providing durable, cost-effective and particularly reliably operated valve devices without for example resorting to expensive valve devices which are prone to faults and are for example pneumatically operated. Moreover the valve device described here can be operated particularly stably in the rotating carousel.

In this case the valve device can have at least one guide bolt along which the valve body is guided. Alternatively it is conceivable to dispense with a guide bolt. This may mean that the valve is or can be operated in a pressure-compensated manner.

According to at least one embodiment, the valve device for controlled introduction of a blowing medium into plastic parisons comprises at least one controllable valve body, at least one actuating device, and also a control device for controlling the actuating device, wherein the actuating device is at least indirectly operatively connected to the valve body. In this case the actuating device comprises at least one piezoelectric actuator, wherein by means of actuation of the actuating device and a control of the piezoelectric actuator, which is associated therewith, by the control device in dependence on the current impressed into the piezoelectric actuator and/or the voltage applied thereto the valve body can be moved from an open position into a closed position and vice versa, and in the dosed position a main flow path for introduction of the blowing medium into the plastic parisons is closed.

According to at least one embodiment the actuating device comprises at least one control air connection, through which control air can be guided for mechanical movement of the valve body and/or a sealing piston of the actuating device along a control air channel, wherein in the closed position a flow path is closed or opened by the sealing piston.

In other words, by means of the control air connection described here control air can be used as an imaginary “lever element” for easier movement of the valve body, so that in such an embodiment the actuating device comprising the piezoelectric element described here is for example in indirect contact with the valve body itself. In this respect the valve body is moved on a control side of the valve body by means of a control pressure generated by the control pressure on a valve surface, so that the sealing piston described here for the actuating device merely serves for control and adjustment of the control air pressure and not directly for adjustment and/or mechanical actuation of the valve body. In this respect the sealing piston of the actuating device and the valve body are not in direct contact with one another in such an embodiment. Amongst other things this also offers the advantage that already slight deflections and/or deformations of the piezoelectric element within the actuating device can act like a lever to effect great changes in a control air through flow and/or control air pressure which is for example transmitted directly to the valve body. In this respect particularly small piezoelectric actuators can be used which only exhibit slight changes in deformation, since they merely have to adjust the control air and the control air through flow through the actuating device. In principle the pressure piston and/or the valve body can actually be controlled by means of a pressure and/or force component.

For calibration purposes a reference travel of the pressure piston and/or of the valve body can be carried out in order to calibrate an end stop of the pressure piston and/or of the valve body.

Moreover it is conceivable that by means of a display screen and an associated processor unit a force/displacement characteristic can be shown as a function of time.

According to at least one embodiment the valve body engages directly with the actuating device, in particular with the piezoelectric actuator. In such a configuration, therefore, the piezoelectric actuator is for example in direct contact with the valve body, so that it is conceivable that by means of an external deformation of the piezoelectric actuator a mechanical movement of the valve body can be effected directly without for example the need to use the control air described above between the piezoelectric actuator and the valve body.

However, a combination of the control air control described here and a direct arrangement of the piezoelectric actuator on the valve body is also conceivable. For example it is conceivable that different piezoelectric actuators can be predeterminably controlled by means of the control device and depending upon the requirements of the user a choice can be made between either a control air operation or a direct engagement of the piezoelectric actuator on the valve body or also any combination of the different modes of operation can be undertaken and controlled.

According to at least one embodiment a lifting movement of a sealing piston of the actuating device and/or a deformation of the piezoelectric actuator are at least partially reversible (also regenerative in the specialist jargon). In this connection “reversible” means that a movement and/or deformation of the piezoelectric actuator or of the sealing piston is repeatable without for example mechanical damage. In this respect the sealing piston described here and/or the piezoelectric actuator described here can be predeterminably reset into the initial state entirely without mechanical structural damage, so that the actuating device described here, in particular the valve device described here, can be used for a practically unlimited number of modes of operation, that is to say open positions and closed positions.

According to at least one embodiment a displacement of a sealing piston of the actuating device can be effected by means of a change in an external shape of the piezoelectric actuator.

Therefore the “external shape” denotes the external configuration and properties of the piezoelectric actuator which are visible for a user from the exterior. If the external shape of the piezoelectric actuator is now changed, this results for example in direct intervention in the movement of the sealing piston. It is therefore conceivable that the piezoelectric actuator is for example mechanically firmly connected directly to the sealing piston. In other words, in a particularly advantageous manner a displacement of a sealing piston of the actuating device can preferably be reversibly produced particularly simply and without the interposition of additional mechanical and/or electrical components by means of the control of the piezoelectric actuator for example by means of voltage and an accompanying change in the external shape of the piezoelectric actuator.

According to at least one embodiment a displacement of a sealing piston of the actuating device can be effected by means of a change in an expansion of the thickness in the lifting direction of the valve body. In this connection it is conceivable that on both sides on cover surfaces of the piezoelectric actuator at least one electrode is disposed in the direction of the thickness of the piezoelectric actuator and the entire piezoelectric actuator is disposed in the lifting direction of the valve piston and/or of the sealing piston behind the sealing piston of the actuating element, and when a voltage is applied for example a thickness of the piezoelectric actuator is reduced, so that the sealing piston of the actuating device is pulled in the direction of the piezoelectric actuator and thus for example the sealing piston opens a control air connection, so that the entire valve body can be pushed or pulled for example in the direction away from the piezoelectric element into a closed position.

According to at least one embodiment the piezoelectric actuator is configured in the form of a piezo stack, comprising at least two piezoelectric part-actuators positioned one behind the other in series and/or connected to one another in series. In this respect each change in thickness of a piezoelectric part-actuator can be added up respectively by a cascading as described here of a plurality of piezoelectric elements connected one behind the other, so that the sum of the changes in thickness of the piezoelectric part-actuators corresponds to an overall change in thickness of the entire piezoelectric actuator. This results in particular in a mechanical series arrangement with control by for example an electrical parallel connection. For this purpose it is conceivable to position a first piezoelectric part-actuator on an electrode (for example a positive connection), then again on an electrode (for example a negative connection) and subsequently further piezoelectric part-actuators alternating regularly with electrodes disposed between them, wherein a direction of polarisation is changed or must be changed. Such cascading can therefore be repeated with almost any frequency. In this case the positive and negative electrodes can each be connected from the exterior.

In other words, the voltages can be applied to the electrodes, so that the distance between the two electrodes increases or reduces in size on the basis of the alteration in length of the piezoelectric part-actuator. In particular in this case a voltage of at least 12 to at most 200 volts is used. Such a voltage range has proved particularly advantageous with regard to the most effective possible change in length.

According to at least one embodiment the valve device comprises at least one energy storage device for storing electrical energy, wherein the storage capacity of the energy storage device is dimensioned in such a way that by means of control and operation of the piezoelectric actuator the valve body and/or a sealing piston of the actuating device can be moved over at least one complete lifting movement. Such an energy storage device enables an especially reliable operation of the valve device, for example in a blow moulding machine. In fact it is conceivable that because of operational disruptions a continuous power supply to the actuating device and thus to the valve device and/or further components of the blow moulding machine is not guaranteed. If due to unforeseen circumstances the power supply to the blow moulding machine and thus to the valve device falls, due to the storage capacity of the energy storage device described here it is possible, in spite of the interruption of an external power supply, for the valve device to move back for example from an open position into a closed position, so that in an unwanted and unforeseen manner blowing air is blown into the plastic parisons for example in an uncontrolled manner during a general shutdown of the blow moulding machine, although the entire blow moulding machine and the movement of the plastic parisons have already been brought to a standstill. In this respect a security mechanism which functions completely without external power supply is provided in a particularly advantageous manner by the energy storage device described here.

According to at least one embodiment the valve device comprises at least one transmission gear for transmitting and transforming a movement and/or a deformation of the piezoelectric actuator to a lifting movement of a sealing piston of the actuating device and/or of a piston of the valve body. For example the transmission gear may be constructed in the form of a “lever transmission element”, so that already a small movement of the piezoelectric actuator can be transformed by the transmission gear into for example a linear movement of the sealing piston increased by predeterminable factors and thus can be transmitted. Therefore the transmission gear described here makes it possible, in the case of valve devices which require large stroke paths, nevertheless to be able to use the piezoelectric actuator described here particularly effectively (although this often exhibits minor changes in thickness), so that due to the transmission gear described here valve devices are produced which may also be used in the case of particularly large cross-sections. In particular the transmission gear may be operable or constructed so as to be self-locking, without play and/or adjustable.

According to at least one embodiment, a sealing surface between a sealing piston of the valve body and a housing of the valve body has a different degree of hardness from the degree of hardness of the piston.

In particular it is conceivable that the piston is constructed with a metal and an inside surface of the housing is constructed with a plastic or vice versa. In this respect it is conceivable that always within the actuating element a metal strikes a plastic and rubs along it. In fact, surprisingly, it has been recognised that such a metal/plastic boundary surface between the sealing piston and an inside surface of the housing of the valve body enables especially low frictional resistances with minimal heat generated, so that as a result an especially durable valve device is created. Thus to summarise, for example, the following boundary surface structure is possible:

piston: metal/plastic
guide: plastic/metal.

Therefore for example metal always rubs on plastic or vice versa.

In this connection it may be mentioned that the transmission gear described here may comprise at least one rotating part and/or at least one linearly moved part. In this connection it is conceivable that such a rotating part can be made from a plastic and a further linearly moved part of the transmission gear can be made from a metal or the opposite material configuration. In this case it has also been recognised that due to such a plastic/metal boundary surface such a transmission gear is especially durable and exhibits not only low frictional resistance and losses but also low heat generation. Thus to summarise, for example, the following boundary surface structure of the transmission gear is possible:

rotating part: plastic/metal
linearly moved part: metal/plastic.

Therefore for example metal always rubs on plastic or vice versa.

According to at least one embodiment the control device is connected to an external voltage and operated by an electrically operated bus system. An electrical bus system described here is a collecting and/or distributing device which for example is centrally controlled, so that the control device described here can be operated for example centrally by means of the electrical bus system by means of a controller device.

According to at least one embodiment a volumetric flow within the main flow path is adjustable by means of a variable stroke length of the sealing piston of the actuating device which can be adjusted by the control device. Such a large stroke length can advantageously be correlated with a particularly fine adjustment of the volumetric flow.

Furthermore a blow moulding device for controlled introduction of a blowing medium into plastic parisons is described, comprising at least one valve device according to at least one of the preceding embodiments as well as a method for operating a blow moulding device. This means that the features listed for the valve device described here are also disclosed for the blow moulding device described here and the method described here, and vice versa.

According to at least one embodiment the blow moulding device comprises at least one controller station, by means of which the control device is monitored and/or controlled. In particular it is conceivable that by means of the controller station described here a predeterminable number, for example all or also only some, of the valve devices of the blow moulding device are monitored and/or controlled predeterminably by means of the control of the respective control devices. In other words, by means of the controller station described here a central processing unit is offered which can detect and/or display a particularly cost-effective and time-saving option for diagnosis for example of operating faults on the individual operating units of the blow moulding device. In this case the controller station may be disposed centrally or away from the centre on the blow moulding device.

Alternatively or additionally it is conceivable that at least one separate controller station is associated with each valve device. For this purpose each controller station may be surrounded by the valve device and for example integrated therein.

According to at least one embodiment of the blow moulding device the positioning of at least one stretching rod in the plastic parison and the control of the piezoelectric actuator by means of the control device are monitored and/or controlled and co-ordinated with one another by the controller station. In this respect it is conceivable that a blow moulding or blow-out process by means of the positioning of the stretching rod in the plastic parison and the control of the piezoelectric actuator can be made dependent upon one another. In fact it is conceivable that, only after a predeterminable final positioning of the stretching rod inside the plastic parison, the valve device is switched from the closed position into the open position, so that by means of such co-ordination of the positioning of the stretching rod and the control of the piezoelectric actuator and making these dependent upon one another it is ensured that unwanted blowing air does not already flow into the plastic parison before the final positioning of the stretching rod within the plastic parison.

According to at least one embodiment a stroke path of the valve body and/or of a sealing piston in the actuating device is parallel to or at an angle of more than 0° and less than 180° to a stroke path of a stretching rod for introduction into the plastic parison. In this respect it is ensured by such a “parallel” orientation of the individual stroke paths that operation is as transmission-free as possible, that is to say that unnecessary and additional mechanical elements for transmission for example of a linear movement and a circular movement, or for example a linear movement in one direction and a linear movement in a different direction, can be omitted. Alternatively it is conceivable that the stroke path of the valve body and/or of a sealing piston is disposed at a predeterminable angle of at most 180° to the stretching rod.

The valve device described here as well as the blow moulding device described here are explained in greater detail below with reference to embodiments and the associated drawings:

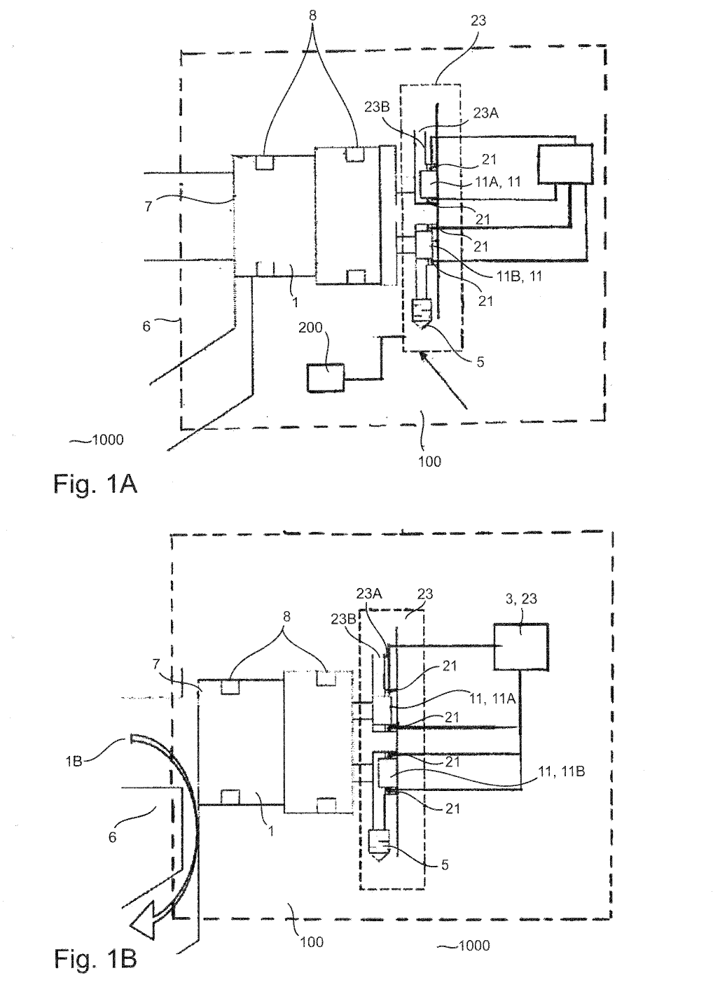

FIGS. 1A-1B show a schematic top view of a first embodiment of a valve device according to the invention;

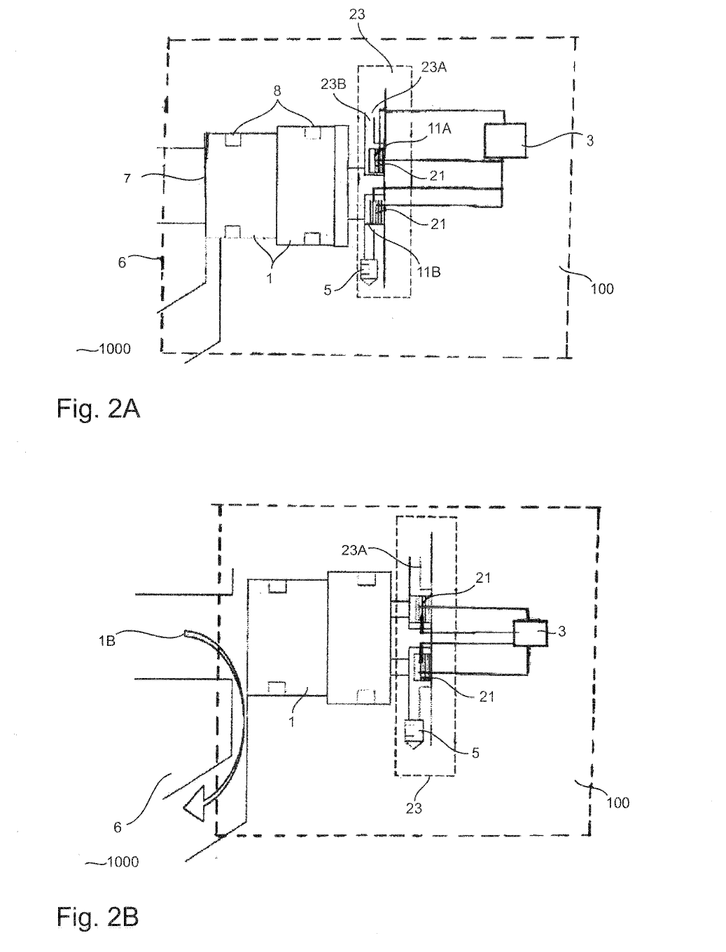

FIGS. 2A-2B show a schematic top view of a further embodiment of a valve device according to the invention;

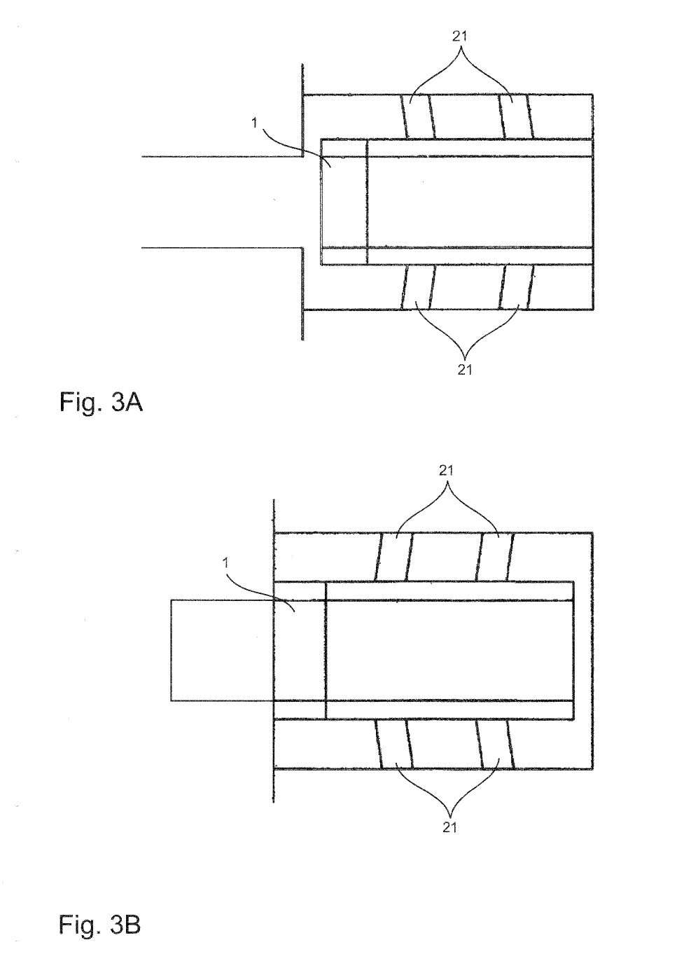

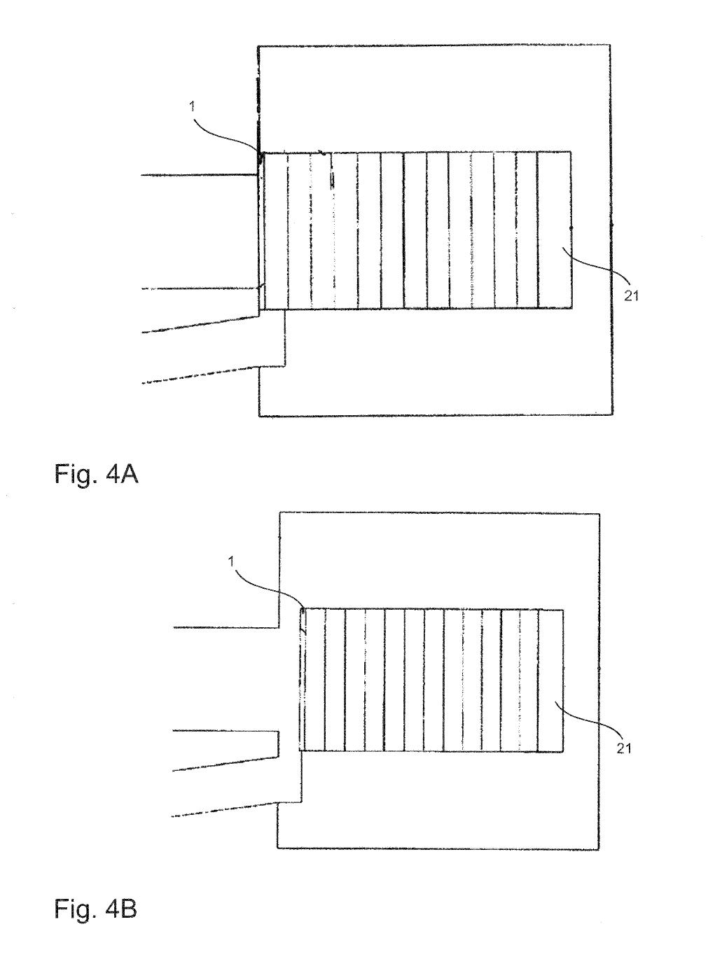

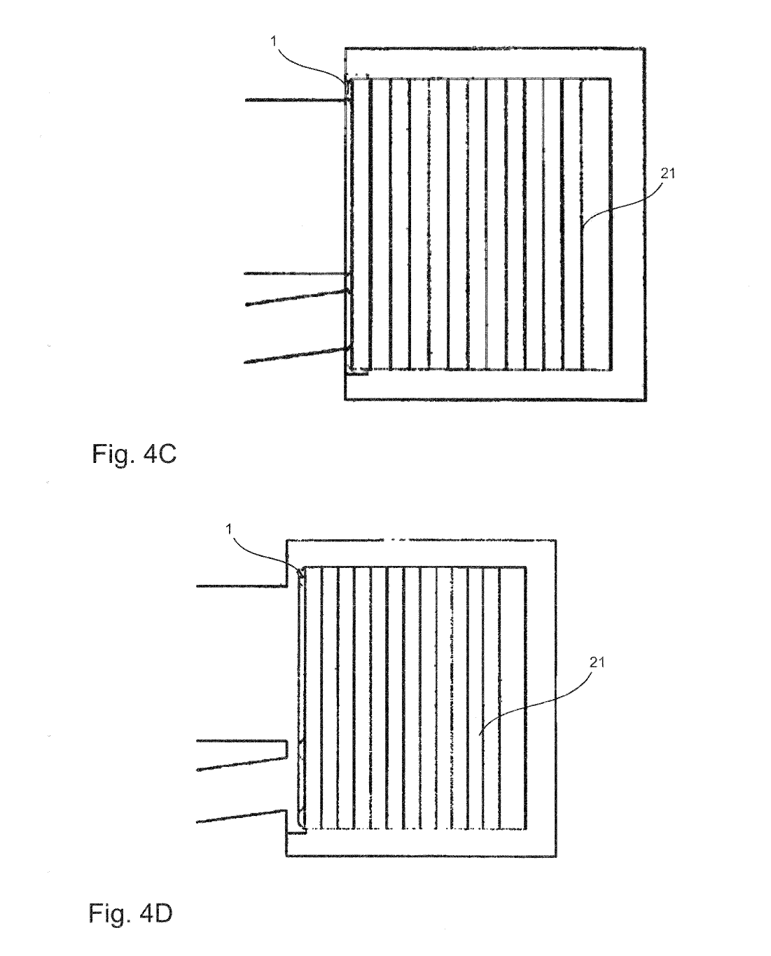

FIGS. 3A-4D show a schematic top view of direct drives of embodiments of a valve device according to the invention;

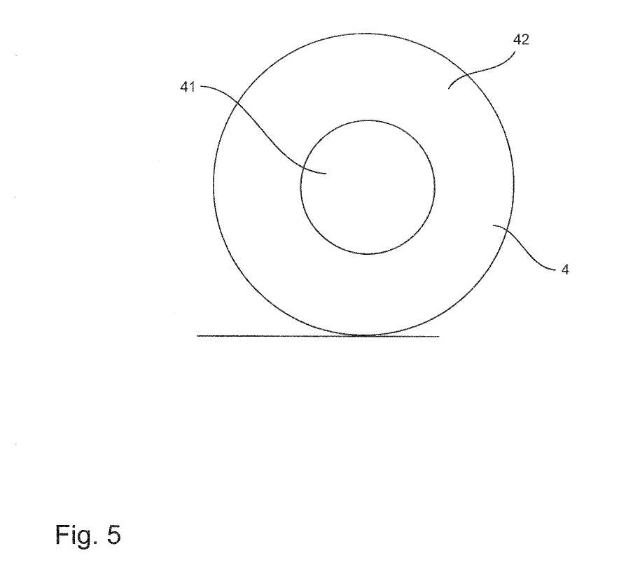

FIG. 5 shows a schematic side view of an embodiment of a transmission gear.

In the embodiments and in the drawings the same or equivalent components are in each case provided with the same reference signs. The illustrated elements should not be regarded as drawn to scale, on the contrary, individual elements may be shown as excessively large to aid understanding.

With reference to a schematic top view, FIG. 1A shows an embodiment of a valve device 100 described here for controlled introduction of a blowing medium 1A into plastic parisons. In this case the valve device 100 in the present embodiment comprises a controllable valve body 1, an actuating device 23 as well as a control device 22 for controlling an actuating device 23, wherein the actuating device 23 is in indirect operative connection with the valve body 1.

In other words the actuating device 23 comprises a control air connection 23A through which control air can be guided for mechanical movement of the valve body 1 along a control air channel 23B, wherein in the closed position of the valve body 1 a flow path through the sealing piston 11A, 11B is opened, so that via the control channel 23B the control air impinges on a surface of the valve body 1 on the control side and displaces the valve body 1 in the direction away from the actuating device 2. In this position of the valve body no blowing air can enter the plastic parison. At the same time it can be seen from FIG. 1A that a further sealing piston 11, 11B closes the control air channel associated with it in an airtight manner, so that in such an embodiment control air once introduced into a housing of the valve body cannot escape through the further control air channel. In this respect a constant pressure is exerted on a piston of the valve body which closes an intermediate channel between a control block 6 of the blow moulding machine and a further or other channel element of a blow moulding machine 1000. In this respect the valve device 100 shown in FIG. 1A is in a closed state.

In this case, as further illustrated in FIG. 1A, the actuating device 23 comprises overall four piezoelectric actuators 21, wherein in each case two piezoelectric actuators 21 are associated with a sealing piston 11A, 11B and can move it. In this respect by means of actuation of the actuating device 23 and a control of the piezoelectric actuators 21, which is associated therewith, by the control device 22 in dependence on the current impressed into the piezoelectric actuators and/or the voltage applied thereto the valve body 1 is moved from an open position into the dosed position shown in FIG. 1A. Moreover each actuating device comprises a controller station 200 by means of which the control device 22 is monitored and/or controlled.

In particular it can be seen that laterally with respect to a lifting direction of the valve body 1 the piezoelectric elements 21 associated with the sealing piston 11A in FIG. 1A are directly connected to the sealing piston 11A on the side faces thereof and in this case have a reversed control polarity relative to those piezoelectric actuators 21 which are associated with the further sealing piston 11B and are fastened thereto. In this respect it is ensured that in the closed state of the valve shown in FIG. 1A the first sealing piston 11A allows control air to pass through and impinge on the valve body 1 and for sealing purposes the second sealing piston 11B completely closes the control air channel associated with it. In this respect the respective piezoelectric actuators 21 of the respective sealing pistons 11A, 11B can be controlled with different voltage polarity. In other words, control of the sealing piston takes place in a combined manner by means of force and displacement. In particular the valve body 1 can be closed by means of force. In this case it is conceivable that the control device 22 of the valve body 1 is disposed in the immediate vicinity of the valve body 1 and/or of the piezoelectric actuators 21. In this case it is also conceivable that the valve device 100 comprises a housing which accommodates at least the piezoelectric actuators 21. Therefore the piezoelectric actuators 21 can be integrated in the housing.

Furthermore the actuating device 2 has at least one sound absorber 5 which damps control air flowing through the further control air channel and sound waves generated thereby.

The valve device 100 shown in FIG. 1A is shown in FIG. 1B in the open position, so that blowing air can flow along a main flow path 1B (shown by the curved arrow) into the channel constructed between the control block 6 and the further component of a blow moulding machine 1000. In this case it may in particular be pointed out that now the two sealing pistons 11A, 11B are disposed in reverse switching directions, so that in FIG. 1B the first sealing piston 11A closes the control air channel 23B associated with it in an airtight manner and in contrast in FIG. 1A the second sealing piston 11B opens the control air channel associated with it, so that for example air can escape via the sound absorber from an air chamber which fills the control side of the valve device 100. For sealing in the event of movement of the valve body 1, seals (for example designed for pressures up to 40 bars) are provided at the edge of the valve body (see FIGS. 1A and 1B).

FIG. 2A shows a schematic side view of a further embodiment of a valve device 100 described here, wherein in contrast to the embodiments according to FIGS. 1A and 1B the piezoelectric actuators 21 are in each case constructed in the form of piezo stacks which comprise at least two piezoelectric part-actuators positioned in series one behind the other and connected in series to one another. In this respect the piezoelectric actuators 21 shown there are disposed in the lifting direction of the valve body 1 behind respective sealing pistons 11A and 11B associated with them. In other words therefore the respective sealing pistons 11A and 11B are disposed between the valve body 1 and the respective piezoelectric actuators 21. In this respect a change in thickness and/or shape of the piezoelectric actuators 21 is exploited by the control of the respective piezoelectric actuators 21 by means of the control device 22. Such a change in thickness is produced by the individual changes in thickness of the respective piezoelectric part-actuators, so that respective individual changes in thickness of the piezoelectric part-actuators are added together and thus give an overall change in thickness of the piezoelectric actuators 21.

In FIG. 2B the valve device 100 shown in FIG. 2A is shown in an open state. Again it may be recognised that a main flow path 1B is opened and thus blowing air between the control block 6 and a further component of the blow moulding device 1000 can reach the plastic parison, for example by means of stretching rods.

Furthermore it can be seen from both the embodiment according to FIGS. 1A and 1B and also the embodiment according to FIGS. 2A and 2B that the respective piezoelectric actuators 21 can be moved and brought over at least a complete stroke length for example from an open position into a closed position by means of at least one energy storage device 3 associated with them for storing electrical energy even after a failure for example of a power supply of the entire blow moulding machine 1000.

FIGS. 3A and 3B show schematic side views of a further embodiment of a valve device 100 described here, wherein the actuating element 2 shown in FIGS. 1A and 1B differs in that the valve body 1 is directly connected to the piezoelectric actuators 21 illustrated there. In this respect in FIGS. 3A and 3B an indirect control of the valve body 1 is omitted by means of the control air, so that the most direct transformation possible of the mechanical deformation of the piezoelectric actuators 21 into a movement of the valve body is offered, wherein in FIG. 3A the valve device 100 is operated in an open position and in FIG. 3B the valve device is operated in a closed position.

FIGS. 4A and 4B show schematic side views of a further embodiment of a valve device 100 described here, wherein in contrast to FIGS. 3A and 3B the respective piezoelectric actuators 21 are constructed in the form of piezo stacks, so that in FIGS. 4A and 4B a change in thickness over the stack-like cascade of individual piezoelectric part-actuators is exploited in order, as shown in FIG. 4A, to close the valve device 100 directly or, as shown in FIG. 4B, to open the valve device 100.

FIGS. 4C and 4D show in further schematic side views a further embodiment of a valve device 100 described here, wherein again by a change in thickness of the piezoelectric actuators 21 shown there (which is likewise formed as a cascade by piezoelectric part-actuators) by mechanically direct means the valve device 100 can be closed or opened and the valve body 1 is directly connected to the piezoelectric actuators 21.

FIG. 5 shows a schematic side view of a transmission gear 4 described here for transmitting and transforming a movement and/or a deformation of the piezoelectric actuator 21 to a lifting movement of a sealing piston 11 of the actuating device 23 and/or of a piston of the valve body 1. In particular it can be seen that the transmission gear 4 shown in a side view of FIG. 5 has a first cylinder element 41 and also comprises a cylinder element 42 directly connected to the first cylinder element 41. In this case the cylinder element 41 and the cylinder element 42 are constructed so as to be mechanically stable, for example in one piece. In particular the cylinder element 41 has a smaller diameter than the cylinder element 42. In this case the piezoelectric element and/or a moving means of the piezoelectric element is for example directly connected to a cylindrical lateral outer surface of the first cylinder element 41 and the sealing piston 11 and/or a moving element of the sealing piston 11 is connected to an external surface of the second cylinder element 42, so that by such a circumferential transformation already a small movement or change in thickness of the piezoelectric element 21 can already be transformed according to the diameter ratios of the cylinder elements 41 and 42 into a correspondingly greater longitudinal movement of the sealing piston 11. This in particular makes it possible for the sealing piston 11 to move in the longitudinal direction of the entire drive.

The invention is not limited by the description of the embodiments. On the contrary, the invention encompasses each new feature as well as any combination of features, in particular including any combination of features of the claims, even if this feature or this combination itself is not explicitly given in the claims or in the embodiments.

### LIST OF REFERENCE SIGNS

1 valve body
1A blowing medium
1B main flow path
3 energy storage device
4 transmission gear
10 sealing surface
11 sealing piston
11A sealing piston
11B further sealing pistons
12 housing
21 piezoelectric actuators
22 control device
23 actuating device
23A control air connection
23B control air channel
41 first cylinder element
42 second cylinder element
100 valve device
200 controller station
1000 blow moulding machine

1. A valve device for controlled introduction of a blowing medium into plastic parisons, comprising at least one controllable valve body, at least one actuating device, and also a control device for controlling the actuating device, wherein the actuating device is at least indirectly operatively connected to the valve body, wherein the actuating device comprises at least one piezoelectric actuator, wherein by actuation of the actuating device and a control of the piezoelectric actuator, which is associated therewith, by the control device in dependence on the current impressed into the piezoelectric actuator and/or the voltage applied thereto, the valve body can be moved from an open position into a closed position and vice versa, and in the closed position a main flow path, for introduction of the blowing medium into the plastic parisons, is closed.

2. The valve device according to claim 1, wherein the actuating device comprises at least one control air connection, through which control air, for mechanical movement of the valve body and/or a sealing piston of the actuating device, can be guided along a control air channel, wherein in the closed position a flow path is closed or opened by the sealing piston.

3. The valve device according to claim 1, wherein the valve body engages directly with the actuating device, in particular with the piezoelectric actuator.

4. The valve device according to claim 1, wherein a lifting movement of a sealing piston of the actuating device and/or a deformation of the piezoelectric actuator is at least partially reversible.

5. The valve device according to claim 1, wherein a displacement of a sealing piston of the actuating device can be effected by a change in an external shape of the piezoelectric actuator.

6. The valve device according to claim 1, wherein a displacement of a sealing piston of the actuating device can be effected by a change in an expansion of the thickness in the lifting direction of the valve body.

7. The valve device according to claim 1, wherein the piezoelectric actuator is configured in the form of a piezo stack, comprising at least two piezoelectric part-actuators positioned one behind the other in series and/or connected to one another in series.

8. The valve device according to claim 1, further comprising at least one energy storage device for storing electrical energy, wherein the storage capacity of the energy storage device is dimensioned such that control and operation of the piezoelectric actuator the valve body and/or a sealing piston of the actuating device can be moved via at least one complete lifting movement.

9. The valve device according to claim 1, further comprising at least one transmission gear for transmitting and transforming a movement and/or a deformation of the piezoelectric actuator to a lifting movement of a sealing piston of the actuating device and/or of a piston of the valve body.

10. The valve device according to claim 1, wherein at least one sealing surface between a sealing piston of the valve body and a housing of the valve body has a different degree of hardness from a degree of hardness of the sealing piston.

11. The valve device according to claim 1, wherein the control device is connected to an external voltage and operated by an electrical bus system.

12. The valve device according to claim 2, wherein a volumetric flow within the main flow path is adjustable by a variable stroke length of the sealing piston of the actuating device which can be adjusted by the control device.

13. A blow moulding device for controlled introduction of a blowing medium into plastic parisons, comprising at least one valve device as claimed in claim 1, wherein the control device is monitored and/or controlled by at least one controller station.

14. The blow moulding device according to claim 13, wherein a positioning of at least one stretching rod in a plastic parison and the control of the piezoelectric actuator by the control device are monitored and/or controlled and co-ordinated with one another by the controller station.

15. The blow moulding device according to claim 13, wherein a stroke path of the valve body and/or of a sealing piston in the actuating device is parallel to or at an angle of more than 0° and less than 1800 to a stroke path of a stretching rod for introduction into the plastic parison.

16. A method for operating a blow moulding device, characterised by providing at least one valve device for controlled introduction of a blowing medium into plastic parisons, wherein the actuating device comprises at least one piezoelectric actuator, wherein by actuation of the actuating device and a control of the piezoelectric actuator, which is associated therewith, by the control device in dependence on the current impressed into the piezoelectric actuator and/or the voltage applied thereto the valve body can be moved from an open position into a closed position and vice versa, and in the closed position a main flow path, for introduction of the blowing medium into the plastic parisons, is closed.
